(19) United States
(12) Patent Application Publication
(10) Pub. No.: US 2017/0206530 A1
(43) Pub. Date: Jul. 20, 2017

(54) Method and system for call authentication and providing reliability

(71) Applicant: THINKAT CO., LTD., Seoul (KR)

(72) Inventor: Wha Cheol Jang, Seoul (KR)

(21) Appl. No.: 15/001,472

(22) Filed: Jan. 20, 2016

(51) Int. Cl. G06Q 20/42; G06Q 10/08; G06Q 20/12; H04L 29/06

(52) U.S. Cl. CPC G06Q 20/425; H04L 63/10; G06Q 10/083; G06Q 20/12

(57) ABSTRACT

Disclosed herein are a method and system for authenticating a user and providing reliability based on phone approval. The method includes receiving, by a service provision server, a service provision request from a first terminal; determining, by the service provision server, whether a type of requested service is service requiring verification of reliability of the user, and transmitting a phone authentication request, including the service type and authentication terminal information about a second terminal, to a phone authentication server; sending, by the phone authentication server, an authentication information request guidance message to the second terminal, acquiring authentication information, performing authentication of the user, and transmitting an authentication result to the service provision server; when the authentication results indicates a success or confirmation of approval, providing requested service to the first terminal; and cumulatively storing the authentication result, and statistically processing the authentication result, thus generating a reliability level.

### BACKGROUND OF THE INVENTION

1. Field of the Invention

The present invention generally relates to a method and system that can check the reliability of a user via authentication based on a call to a registered terminal performed in response to the specific service request of the user.

2. Description of the Related Art

General user identification over the Internet has been performed as real name authentication using the resident registration number of a user, but an Internet Personal Identification Number (I-PIN) that is a personal identification number for replacing a resident registration number has been issued and used in order to prevent the leakage and abuse of resident registration numbers.

Recently, when users subscribe as members to all Internet-based services, such as electronic commerce (E-commerce) and games, so as to use the services, certificate authentication or Short Message Service (SMS) authentication is generalized as an identification means. Further, based on the law regarding the promotion of information and communication network use and protection of information, as ‘identification of message board users’ is obligatorily applied, each user must undergo such an identification procedure when posting a message on a message board, and thus the authentication means for such identification has been diversified.

However, accidents, such the leakage of a large amount of personal information, have frequently occurred due to negligence of system management, and the stealing of an authentication means, such as a certificate that is used as identification means, as well as personal information, has gradually increased due to evolving hacking techniques, such memory hacking, malware, and ZeuS Bots. Further, secondary and tertiary damages may spread in such a way as to post a malicious file on a message board using the stolen personal information and various types of authentication means, and infect the terminals of unspecified users on which the corresponding file is downloaded, thus illegally collecting information about the corresponding users.

Such conventional authentication methods are limited in that they are performed in one way.

In one-way transactions, for a service provided by an Internet service provider, whether a user has requested the use of the service is not checked, and thus it is difficult to check whether the service use request is authentic or not. Even if the checking of the authenticity of the service request has been requested, authentication (approval) information is input to the same channel such as a PC, and thus the service request may be randomly fabricated due to hacking at the input and checking step.

On the presumption that Internet-based services are non-face-to-face services and are services implemented without temporal and spatial restrictions, a user identification procedure and method, and mutual reliability between parties directly involved in service trading are considered to be the most important thing. In particular, methods and means for checking the use of service and authenticating parties directly involved in service trading may be provided when there is a high probability that illegal transactions will occur using stolen personal information and illegally acquired information.

Korean Patent Application Publication No. 2001-0055118 (Jul. 4, 2001) discloses a method for performing authentication using a certificate issued via a public institution.

### PRIOR ART DOCUMENTS

### Patent Documents

(Patent Document 1) Korean Patent Application Publication No. 2001-0055118 (2001.07.04)

### SUMMARY OF THE INVENTION

Accordingly, the present invention has been made keeping in mind the above problems occurring in the prior art, and an object of the present invention is to provide a method and system that can check the reliability of an actual user by performing authentication based on a call to a registered terminal so as to use a specific service.

Another object of the present invention is to provide a user authentication method and system based on phone approval, which perform authentication using a separate terminal via communication between a server for providing service and a server for performing phone authentication (call authentication) without causing a terminal that requested the service to perform authentication, thus making it impossible to perform forgery or falsification.

A further object of the present invention is to provide a user authentication method and system based on phone approval, which request a user to enter approval or rejection for the user's transaction request via one-way authentication, and process the transaction based on the entered result, thus strengthening an identification function and a non-repudiation function.

Yet another object of the present invention is to provide a user authentication method and system based on phone approval, which are capable of preventing abnormal transactions in advance and which allow the system to automatically notify a user of the occurrence of a symptom such as suspected hacking, or allow the user to perceive the symptom and immediately make a report, thus preventing the occurrence of accidents related to security.

In accordance with an aspect of the present invention, there is provided a method for authenticating a user and providing reliability.

According to an embodiment of the present invention, there is a provided a method authenticating a user in response to a service request of a first terminal, including receiving, by a service provision server, a service provision request from the first terminal; determining, by the service provision server, whether a type of service requested to be provided to the first terminal is a service requiring verification of reliability of the user, and transmitting, by the service provision server, a phone authentication request for the user, which includes the service type and authentication terminal information about a previously registered second terminal, to a phone authentication server if it is determined that the requested service is the service requiring verification of reliability; sending, by the phone authentication server, an authentication information request guidance message including the service type to the previously registered second terminal, acquiring authentication information, performing authentication of the user, and transmitting a result of authentication to the service provision server; when the result of authentication indicates success of authentication or confirmation of approval, providing, by the service provision server, the requested service to the first terminal; and cumulatively storing, by the service provision server, the result of authentication, and statistically processing the stored authentication result, thus generating a reliability level.

The type of service requiring verification of reliability may be at least one of a member subscription request, a login request, an information change request, a content upload and download request, an information posting request, an adult information access request, and an electronic commerce request.

Each of the first terminal and the second terminal may include a plurality of terminals, wherein when the type of service is electronic commerce, any one of the plurality of first terminals is a seller terminal and another one thereof is a purchaser terminal, and when any one of the plurality of second terminals is a seller authentication terminal, and another one thereof is a purchaser authentication terminal.

The method may further include, when the type of service is electronic commerce, extracting, by the service provision server, commodities, delivery of which has been completed and which are waiting for a purchase decision to be made, from commodities purchased by the purchaser; transmitting, by the service provision server, a purchase decision authentication request to the phone authentication server, wherein the purchase decision authentication request includes purchase information and recipient contact information registered when delivery of the extracted commodities, waiting for a purchase decision to be made, is requested; transmitting, by the phone authentication server, a purchase decision confirmation request including the purchase information to a terminal of a recipient using the recipient contact information, acquiring purchase decision response information, and transmitting the purchase decision response information to the service provision server; and updating, by the service provision server, a purchase confirmation state using the purchase decision response information.

The purchase decision response information may be acquired via Dual Tone Multi-Frequency (DTMF).

The method may further include, when checking of reliability of the user of the first terminal is requested by an additional terminal, providing, by the service provision server, the reliability level so that the reliability level is displayed on the additional terminal.

In accordance with another aspect of the present invention, there is provided a system for authenticating a user and providing reliability.

The system of the present invention includes a service provision server for receiving a service provision request from the first terminal, determining whether a type of service requested to be provided to the first terminal is a service requiring verification of reliability of the user, transmitting a phone authentication request for the user, which includes the service type and authentication terminal information about a previously registered second terminal, to a phone authentication server if it is determined that the requested service is the service requiring verification of reliability, receiving a result of authentication from the phone authentication server, and providing the service requested to be provided to the first terminal if the result of authentication indicates success of authentication or confirmation of approval; and the phone authentication server for receiving the phone authentication request from the service provision server, sending an authentication information request guidance message including the service type to the previously registered second terminal, acquiring authentication information, performing authentication of the user, and then transmitting a result of user authentication to the service provision server, wherein the service provision server cumulatively stores the result of authentication, and statistically processes the stored authentication result, thus generating a reliability level.

The type of service requiring verification of reliability may be at least one of a member subscription request, a login request, an information change request, a content upload and download request, an information posting request, an adult information access request, and an electronic commerce request.

When the type of service is electronic commerce, the service provision server may extract commodities, delivery of which has been completed and which are waiting for a purchase decision to be made, from commodities purchased by the purchaser, and transmit a purchase decision authentication request to the phone authentication server, wherein the purchase decision authentication request includes purchase information and recipient contact information registered when delivery of the extracted commodities, waiting for a purchase decision to be made, is requested, the phone authentication server may transmit a purchase decision confirmation request including the purchase information to a terminal of a recipient using the recipient contact information, acquire purchase decision response information, and transmit the purchase decision response information to the service provision server, and the service provision server may update a purchase confirmation state using the purchase decision response information.

The service provision server may be configured to, when checking of reliability of the user of the first terminal is requested by an additional terminal, provide the reliability level so that the reliability level is displayed on the additional terminal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram schematically showing the configuration of a phone authentication-based user authentication system for online service usage according to an embodiment of the present invention;

FIG. 2 is a flowchart showing a method for providing service in response to the service request of a first terminal in the user authentication system according to an embodiment of the present invention;

FIG. 3 is a flowchart showing a phone authentication procedure according to an embodiment of the present invention;

FIG. 4 is a diagram showing a screen on which reliability levels are displayed according to an embodiment of the present invention;

FIG. 5 is a flowchart showing a phone authentication procedure performed when subscription as a member to a service provision server is made according to an embodiment of the present invention;

FIG. 6 is a diagram showing a phone authentication procedure performed when the first terminal transmits a login request or an information change service request to the service provision server according to an embodiment of the present invention;

FIG. 7 is a flowchart showing a phone authentication procedure performed in response to an authentication terminal change request required to check the reliability of the user of the first terminal according to an embodiment of the present invention;

FIG. 8 is a flowchart showing a phone authentication procedure required to check the reliability of a seller and a purchaser based on e-commerce according to an embodiment of the present invention;

FIG. 9 is a diagram showing a phone authentication procedure performed upon waiting for a commodity purchase decision to be made in e-commerce in the method of FIG. 8 according to an embodiment of the present invention;

FIG. 10 is a diagram showing items required to evaluate the reliability level of a user according to an embodiment of the present invention; and

FIGS. 11 and 12 are diagrams showing screens on which a phone authentication reliability service is provided according to an embodiment of the present invention.

### DESCRIPTION OF THE PREFERRED EMBODIMENTS

The present invention may be variously changed and may have various embodiments, and specific embodiments will be illustrated in the accompanying drawings and described in detail with reference to the drawings. However, it should be understood that those embodiments are not intended to limit the present invention to specific embodiments and they include all changes, equivalents or modifications included in the spirit and scope of the present invention. In the description of the present invention, detailed descriptions of known functions and configurations which have been deemed to make the gist of the present invention unnecessarily obscure will be omitted below.

Further, the terms “first” and “second” can be used to describe various components, but and those components are not limited by the terms. The terms are only used to distinguish one component from other components.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

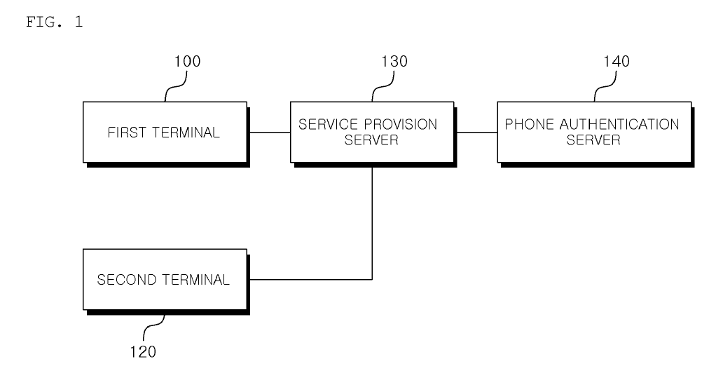

Embodiments of the present invention will be described in detail with reference to the accompanying drawings.

[Description of FIG. 1]

FIG. 1 is a block diagram schematically showing the configuration of a phone authentication-based user authentication system based on the use of online service according to an embodiment of the present invention.

Referring to FIG. 1, the user authentication system includes a first terminal 110, a second terminal 120, a service provision server 130, and a phone authentication server 140.

The first terminal 110 is a device connected to a service provision server 130 over a wired/wireless communication network and provided with various services from the corresponding service provision server 130.

For example, the types of first terminal 110 may include a computer, a notebook, a mobile communication terminal, a smart phone, a tablet Personal Computer (PC), a Personal Digital Assistant (PDA), etc. In addition, it is apparent that any type of device having a communication function may be equally used as the first terminal 110.

The second terminal 120 is a device for transmitting authentication information in response to an authentication request received from the phone authentication server 140.

The second terminal 120, which is a device registered or designated by the first terminal 110 so as to be provided with a specific service from the service provision server 130, may be connected to the phone authentication server 140 and may provide authentication information for user authentication to the phone authentication server 140.

For example, any type of device capable of performing a call function, such as a mobile communication terminal or a wired telephone, may be equally used as the second terminal 120.

The service provision server 130 is a device for providing various types of services over a communication network.

For example, the service provision server 130 may request the phone authentication server 140 to authenticate the user of the first terminal 110 in response to a service provision request received from the first terminal 110, acquire the result of authentication from the phone authentication server 140, and provide the service requested to be provided to the first terminal 110, based on the result of authentication.

For example, the service provision server 130 may be an agent server for mediating commodities to sell the commodities in an online environment or a game server for providing game programs in an online environment. That is, any type of device for providing a specific service online may be equally used as the service provision server 130.

The phone authentication server 140 is a means operated in conjunction with the service provision server 130, and configured to acquire authentication information from the second terminal 120 and authenticate the user of the first terminal 110 in order to provide the service from the service provision serve 130 to the first terminal 110.

For example, to provide service to the first terminal 110 in response to the request of the service provision server 130, the phone authentication server 140 requests the second terminal 120 to authenticate the user of the first terminal 110, acquires authentication information, authenticates the user using the authentication information, and then provides the result of authentication to the service provision server 130.

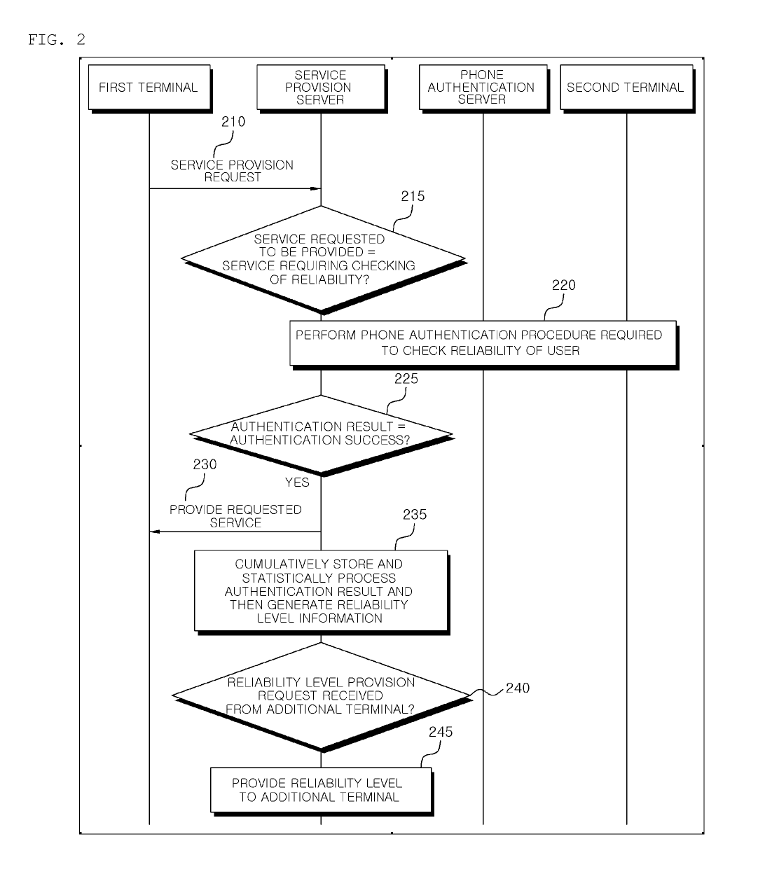

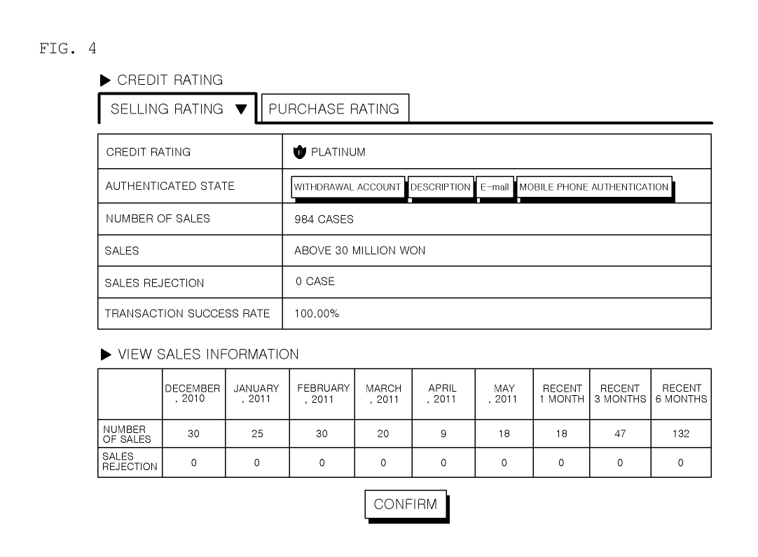

Further, the phone authentication server 140 may be special resource for performing functions such as voice guidance, voice recognition, Dual Tone Multi-Frequency (DTMF) collection, and Text-To-Speech (TTS) conversion, which are required to authenticate the user of the first terminal 110 as the first terminal uses the service. For example, the phone authentication server 140 may be the Intellectual Peripheral (IP) of an intelligence network system.

[Description of FIGS. 2 and 4]

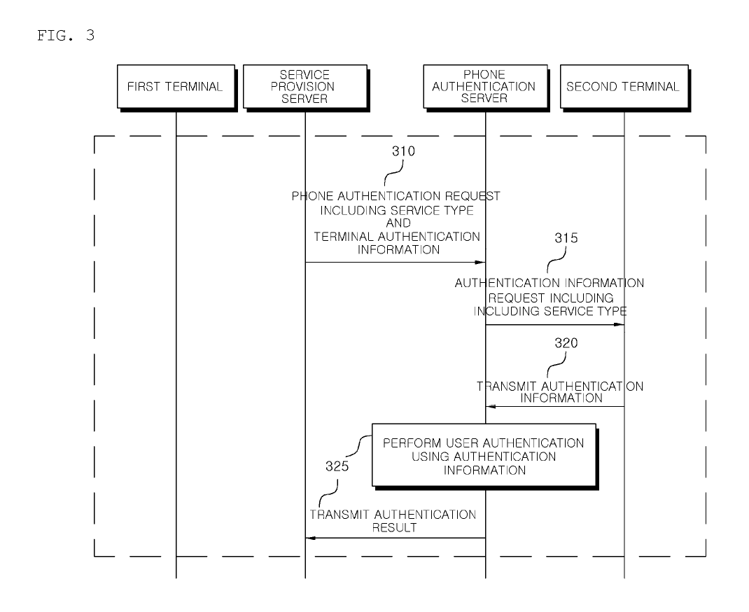

FIG. 2 is a flowchart showing a method for providing service in response to the service request of a first terminal in the user authentication system according to an embodiment of the present invention, FIG. 3 is a flowchart showing a phone authentication procedure according to an embodiment of the present invention, and FIG. 4 is a diagram showing a screen on which reliability levels are displayed according to an embodiment of the present invention.

At step 210, the service provision server 130 receives a service provision request from the first terminal 110.

Accordingly, at step 215, the service provision server 130 determines whether the service requested by the first terminal 110 is a service requiring the checking of reliability of the user.

For example, in the present specification, the type of service requiring the checking of the reliability of the user may be at least one of a login request, an information change request (e.g. a user information change request, an authentication terminal information change request, or the like), a content upload and download request, an information posting request, an adult information access request, and an e-commerce request.

If the service is the service requiring the checking of the reliability of the user, the service provision server 130 performs phone authentication required to check the reliability of the user and acquires the result of authentication while operating in conjunction with the phone authentication server 140 at step 220.

For the convenience of understanding and description of the invention, a phone authentication procedure will be described with reference to FIG. 3.

At step 310, the service provision server 130 transmits a phone authentication request to the phone authentication server 140, wherein the phone authentication request includes both information about the service requested to be provided to the first terminal 110 (for the convenience of understanding and description of the invention, hereinafter referred to as a “service type”) and authentication terminal information about a second terminal registered or designated by the first terminal 110.

Accordingly, at step 315, an authentication information request guidance message including the service type is transmitted to the previously registered second terminal 120.

At step 320, the phone authentication server 140 acquires authentication information from the second terminal 120.

For example, the phone authentication server 140 may acquire the authentication information from the second terminal 120 using DTMF.

At step 325, the phone authentication server 140 performs authentication required to check the reliability of the user of the first terminal 110 using the authentication information, and thereafter transmits the result of authentication to the service provision server 130.

In this way, when the first terminal 110 requests a specific service through the service provision server 130, the service provision server 130 may perform phone authentication required to check the reliability of the user and acquire the result of authentication while operating in conjunction with the phone authentication server 140.

Referring back to FIG. 2, at step 225, the service provision server 130 determines whether the result of authentication acquired from the phone authentication server 140 indicates the success of authentication or the confirmation of approval.

If the result of authentication indicates the success of authentication, the service provision server 130 provides the service, requested to be provided to the first terminal 110, to the first terminal 110 at step 230.

However, if the result of authentication indicates the failure of authentication, the service provision server 130 repetitively performs the phone authentication procedure corresponding to step 220 for a preset number of times.

At step 235, the service provision server 130 cumulatively stores the authentication result of the first terminal 110, statistically processes the stored authentication results, and generates information about the reliability level of the user of the first terminal 110.

Then, at step 240, the service provision server 130 determines whether a request to provide the reliability level of the user of the first terminal 110 has been received from an additional user.

If the reliability level provision request has been received, the service provision server 130 may provide the reliability level information of the user of the first terminal 110 to an additional terminal and display the information on the additional terminal at step 245. FIG. 4 illustrates an example in which the reliability level information of the user of the first terminal 110 is provided to and displayed on the additional terminal.

However, if a reliability level provision request has not been received, the process is waiting at step 240.

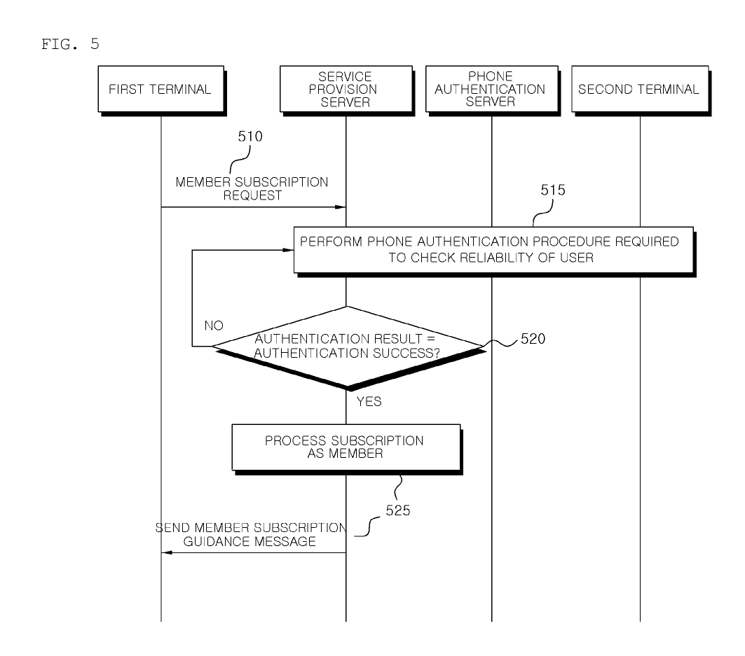

Hereinafter, a phone authentication method for checking the reliability of a user depending on each service will be described in detail.

[Description of FIG. 5]

FIG. 5 is a flowchart showing a phone authentication procedure performed when subscription as a member to a service provision server is made according to an embodiment of the present invention.

At step 510, the service provision server 130 receives a member subscription request from the first terminal 110. Here, the member subscription request may include user information required to subscribe as a member to the service provision server 130. Here, the user information may include at least one of basic profile information and account information of the user. Further, the account information may include an Identification (ID) and a password, and may include additional information, such as I-PIN, required to identify the user.

Here, the member subscription request may further include authentication terminal information required to check the reliability of the user of the first terminal 110.

Then, at step 515, the service provision server 130 performs the phone authentication procedure of FIG. 3 while operating in conjunction with the phone authentication server 140. Here, the phone authentication server 140 may acquire authentication information by sending an authentication information request guidance message such as “Please enter the number 00 to subscribe to this service. If you listen again, enter the number 1, and if you reject the subscription, enter the number 2, and if this is not for your transaction or is not a service you requested, enter *.” to the second terminal 120 using the authentication terminal information, and may then perform phone authentication.

As described above, the phone authentication server 140 may acquire authentication information from the second terminal 120 using DTMF. Hereinafter, even if an additional description is not made in the present specification, it should be understood that the phone authentication server 140 acquires authentication information or the like using DTMF from a terminal for authentication (e.g. the second terminal or the like).

At step 520, the service provision server 130 determines whether the result of authentication indicates the success of authentication.

If the result of authentication indicates the failure of authentication, the service provision server 130 repeatedly performs the phone authentication procedure corresponding to step 520 a preset number of times.

In contrast, if the result of authentication indicates the success of authentication, the service provision server 130 registers the user of the first terminal 110 as a member at step 525.

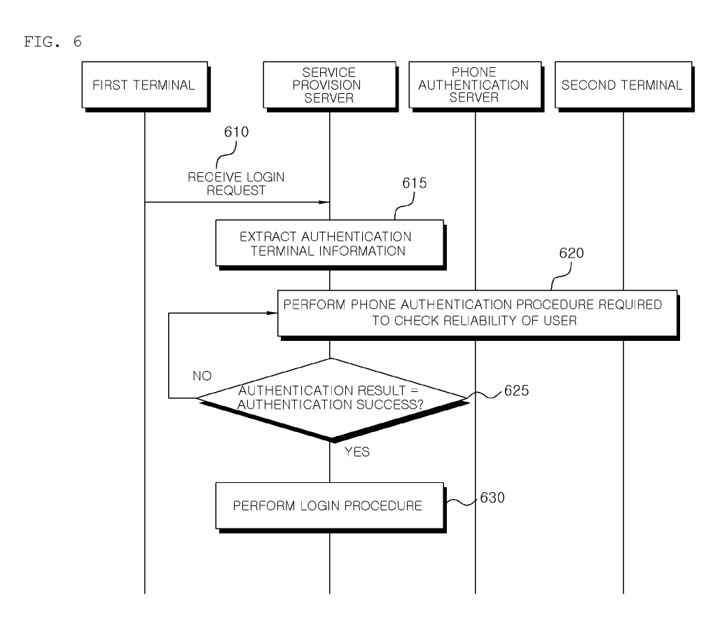

Then, when the member subscription has been completed, the service provision server 130 sends a guidance message indicating the normal completion of member subscription to the first terminal 110.

[Description of FIG. 6]

FIG. 6 is a diagram showing a phone authentication procedure performed when the first terminal 110 transmits a login request or an information change service request to the service provision server according to an embodiment of the present invention. Below, repeated descriptions of components identical to those of FIGS. 2 to 5 will be omitted, and only different portions will be described.

Referring to FIG. 6, the service provision server 130 receives a login request through the first terminal 110 at step 610. Here, on the assumption that, when the first terminal 110 subscribes as a member, authentication terminal information required to check the reliability of the user of the first terminal 110 has been registered and stored in the service provision server 130, a subsequent procedure will be described.

Then, the service provision server 130 extracts authentication terminal information, registered to correspond to the first terminal 110, from a database (DB) (not shown) in response to the login request of the first terminal 110 at step 615. Then, the service provision server 130 may perform a phone authentication procedure by transmitting a phone authentication request including at least one of the authentication terminal information and a service type to the phone authentication server 140 at step 620 (the phone authentication procedure is the same as that described with reference to FIG. 3, and thus a repeated description thereof will be omitted).

The service provision server 130 acquires the result of authentication of the user of the first terminal 110 from the phone authentication server 140 that operates in conjunction with the service provision server 130, and determines whether the result of authentication indicates the success of authentication at step 630. If the result of authentication indicates the success of authentication, the service provision server 140 may perform a login procedure for the first terminal 110 at step 635.

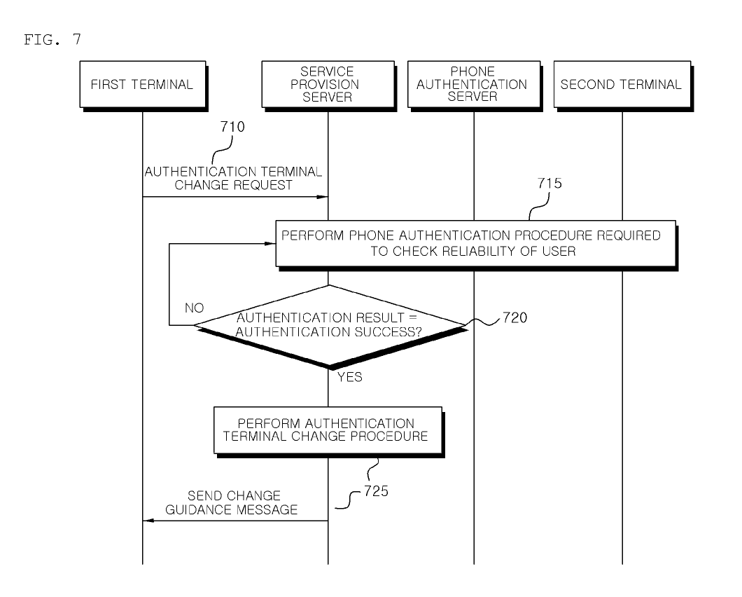

In this way, when the first terminal 110 requests an information change service from the service provision server 130 in the state in which it has logged in to the service provision server 130, the phone authentication procedure of FIG. 3 may be further performed, and thereafter previous information may be changed to and registered as the information requested by the first terminal 110.

[Description of FIG. 7]

FIG. 7 is a flowchart showing a phone authentication procedure performed in response to an authentication terminal change request required to check the reliability of the user of the first terminal according to an embodiment of the present invention.

Below, repeated descriptions of components identical to those of FIGS. 2 to 5 will be omitted, and only different portions will be described.

At step 710, the first terminal 110 transmits an authentication terminal change request to the service provision server 130. Here, the authentication terminal change request may include information about an authentication terminal before change is made, and information about an authentication terminal after the change is made.

At step 715, the service provision server 130 transmits a phone authentication request, including the information about the authentication terminal after the change is made, to the phone authentication server 140 in response to the authentication terminal change request, and then performs a phone authentication procedure. This procedure is identical to that described with reference to FIG. 3, and thus a repeated description will be omitted. However, there is a difference from FIG. 3 in that the phone authentication procedure at step 715 is performed by requesting authentication information from a target authentication terminal rather than by acquiring the authentication information from the second terminal.

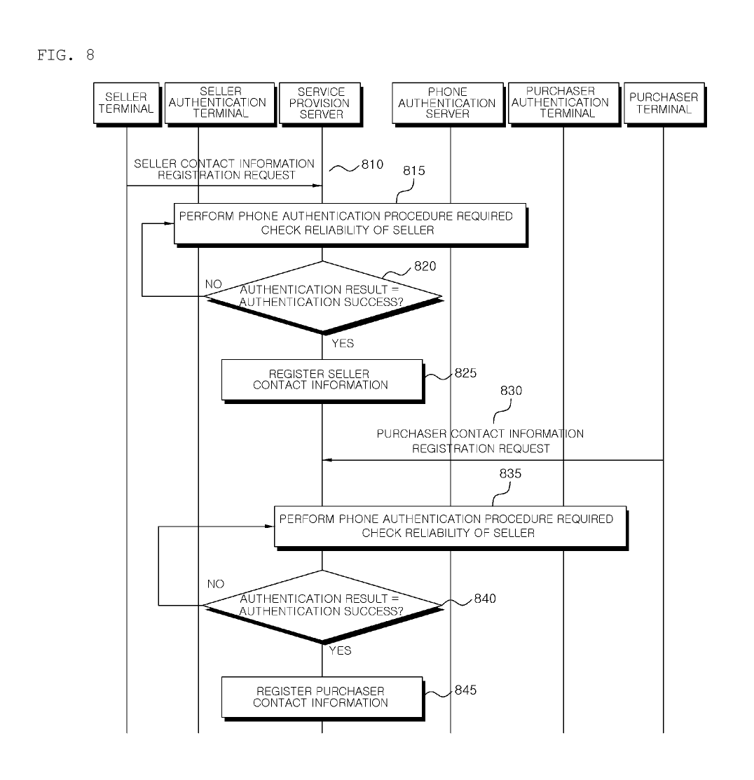

Thereafter, when the result of authentication indicates the success of authentication, the service provision server 130 performs an authentication terminal change procedure in response to the authentication terminal change request at steps 720 and 725.

[Description of FIG. 8]

FIG. 8 is a flowchart showing a phone authentication procedure required to check the reliability of a seller and a purchaser based on e-commerce according to an embodiment of the present invention.

At step 810, a seller terminal transmits a seller contact information registration request to the service provision server 130. Here, the seller contact information registration request may include authentication terminal information required to authenticate the seller. For the convenience of understanding and description of the invention, the contact information of the seller is called ‘seller authentication terminal information’.

At step 815, the service provision server 130 performs a phone authentication procedure required to check the reliability of the seller while operating in conjunction with the phone authentication server 140 in response to the seller contact information registration request.

This is identical to the phone authentication procedure described above with reference to FIG. 3, except that a target terminal, the authentication information of which is acquired for phone authentication, is a seller authentication terminal. The remaining components are identical to those of FIG. 3, and thus a repeated description thereof will be omitted.

Then, at step 820, the service provision server 130 determines whether the result of authentication indicates the success of authentication. If the result of authentication indicates the success of authentication, the service provision server 130 registers seller contact information in the service provision server 130 at step 825.

Below, a method for registering purchaser contact information will be described. For the convenience of description in the present specification, the purchaser contact information registration method is shown to be performed after the seller contact information registration method has been performed, but it is apparent that the purchaser contact information registration method and the seller contact information registration method may be performed in parallel.

Then, at step 830, the service provision server 130 receives a purchaser contact information registration request from a purchaser terminal. Here, the purchaser contact information registration request may include authentication terminal information required to authenticate the purchaser. For the convenience of understanding and description of the invention, the contact information of the purchaser is called ‘purchaser authentication terminal information’.

At step 835, the service provision server 130 performs a purchaser phone authentication procedure in response to the purchaser contact information registration request while operating in conjunction with the phone authentication server 140. This is identical to the phone authentication procedure described above with reference to FIG. 3, except that an agent for transmitting authentication information is the purchaser authentication terminal, and thus a repeated description thereof will be omitted.

At step 840, the service provision server 130 determines whether the result of authentication indicates the success of authentication, and registers the purchaser contact information in the service provision server 130 at step 845 if the result of authentication indicates the success of authentication.

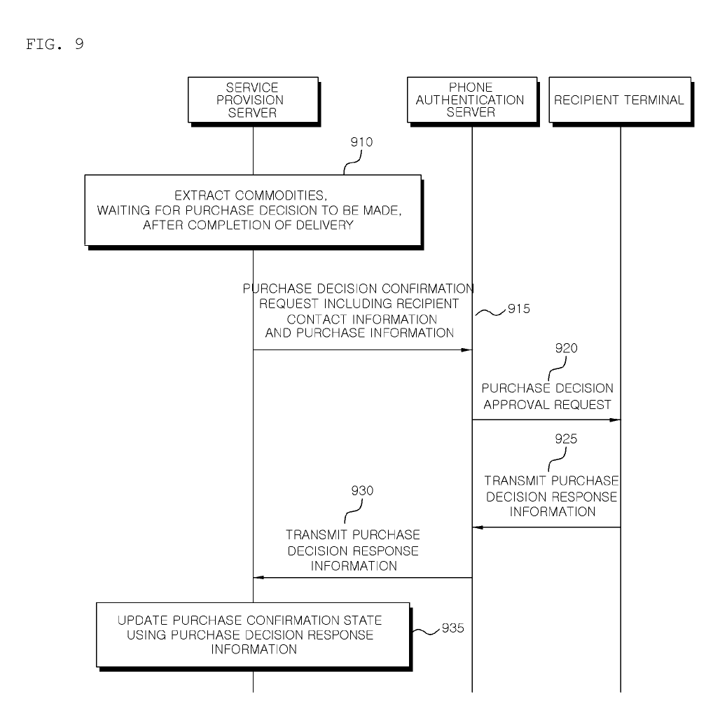

The phone authentication procedures for checking the reliability of the seller and the purchaser at steps 815 and 835 may also be performed when a separate verification condition is satisfied. For example, the verification condition may be at least one of the case where the time at which contact information is registered exceeds a preset period, the case where the number of sales of each commodity by the seller for a predetermined period of time is less than or equal to a predetermined number (or the case where the number of purchases of each commodity by the purchaser is less than or equal to a predetermined number), and the case where a designated interval has arrived (e.g. an interval of 10 to 12 p.m., an interval of 2 to 5 p.m., etc.).

[Description of FIG. 9]

FIG. 9 is a diagram showing a phone authentication procedure performed upon waiting for a commodity purchase decision to be made in e-commerce in the method of FIG. 8 according to an embodiment of the present invention.

Below, a procedure, performed when a purchase confirmation state is a purchase decision waiting state after a specific commodity has been purchased by a purchaser and the delivery of the commodity has been completed, will be described.

At step 910, the service provision server 130 extracts commodities, the delivery state of which indicates “delivery completed”, and the purchase confirmation state of which indicates “waiting for purchase decision”.

At step 915, the service provision server 130 transmits a purchase decision confirmation request, including at least one of purchase information and recipient contact information, registered by the purchaser terminal when the delivery of extracted commodities which are waiting for a purchase decision to be made is requested, to the phone authentication server 140. Here, when a designated verification condition is additionally satisfied, the service provision server 130 may transmit a purchase decision authentication request to the phone authentication server 140. Since the verification condition is identical to the above-described condition, a repeated description thereof will be omitted.

Accordingly, at step 920, the phone authentication server 140 may transmit a purchase decision approval request including the purchase information to a recipient terminal using the recipient contact information.

For example, the phone authentication server 140 may send the purchase decision approval request such as “Please enter the number 00 to make a purchase decision for commodity 00 delivered from site 00 at date 00. If you listen again, enter the number 1, and if you cancel the purchase, enter the number 2, and if this is not for your transaction or is not a service you requested, enter *”.

Thereafter, at step 925, the phone authentication server 140 acquires purchase decision response information from the recipient terminal in response to the purchase decision approval request. Here, the purchase decision response information may be at least one of approval, cancellation, and report. In this case, the purchase decision response information may be acquired through DTMF.

At step 930, the phone authentication server 140 transmits the acquired purchase decision response information to the service provision server 130.

Accordingly, at step 935, the service provision server 130 updates the purchase confirmation state for the corresponding commodity using the purchase decision response information received from the phone authentication server 140.

The service provision server 130 may cumulatively store the purchase decision response information for each commodity through the phone authentication server 140, statistically process the stored information, and provide purchase confirmation information to each seller.

At this time, the service provision server 130 may provide purchase confirmation information to the seller for each commodity item, or may provide purchase confirmation information to the seller at a designated time every designated period.

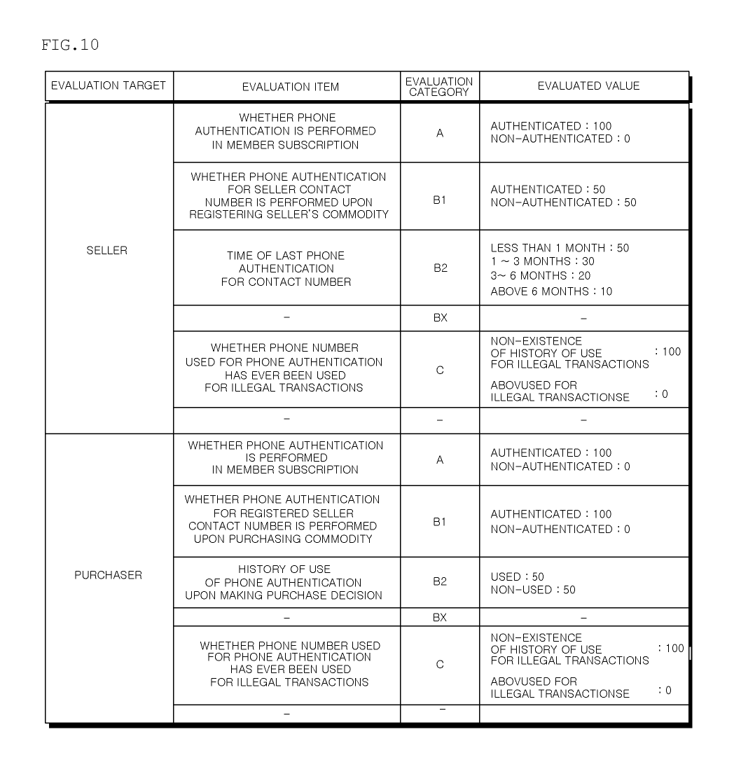

The above procedure may be equally applied to an information posting request, a content download and upload request, an adult authentication request, etc. in addition to the service types described above with reference to FIGS. 6 to 9. This is identical to the above description, and thus a repeated description thereof will be omitted.

[Description of FIG. 10]

FIG. 10 is a diagram showing items required to evaluate the reliability level of a user according to an embodiment of the present invention.

Referring to FIG. 10, to evaluate the reliability levels of a seller and a purchaser, respective evaluation items, such as whether phone authentication based on a call to each contact number has been performed, and whether each contact number has ever been used for illegal transaction, are defined, and evaluated values are statistically processed for respective evaluation items, and then final reliability levels may be calculated.

FIG. 10 illustrates evaluated values for respective evaluation items for the convenience of understanding and description of the invention, but it is apparent that respective evaluation items may be designated and evaluated values may be set using various methods in addition to the illustrated method.

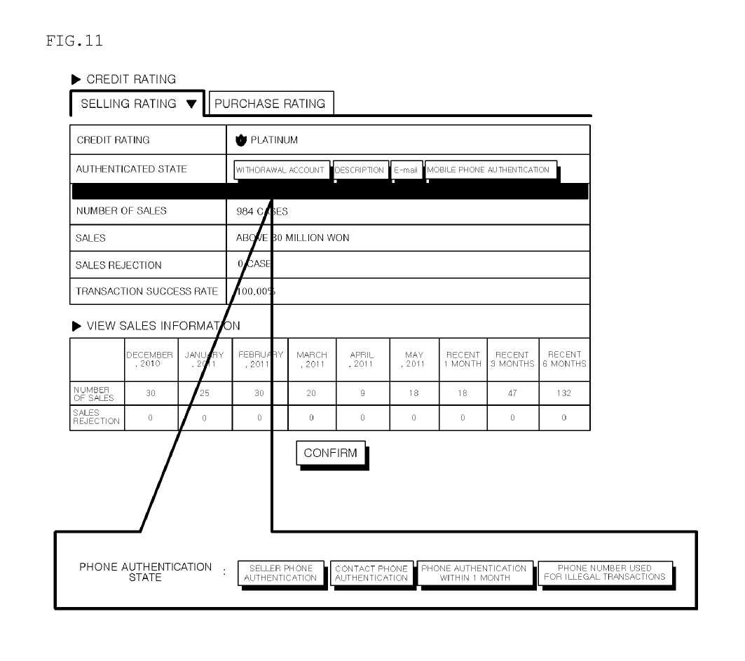

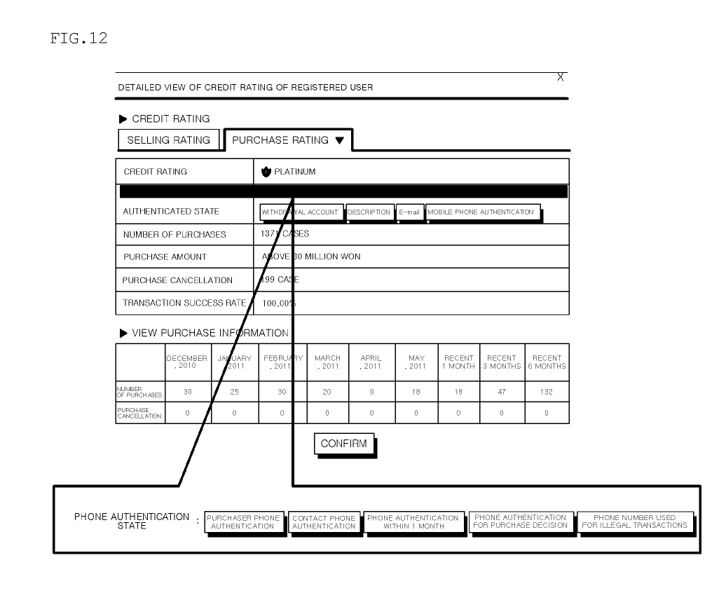

Further, FIG. 10 illustrates a table required to evaluate the reliability levels of a purchaser and a seller based on e-commerce, but it is apparent that log histories for respective users may be stored, evaluation items for respective log histories may be designated, and then the reliability levels of the users may be calculated.

[Description of FIGS. 11 and 12]

FIGS. 11 and 12 are diagrams showing screens on which a phone authentication reliability service is provided according to an embodiment of the present invention.

As shown in FIG. 11, along with the provision of the reliability level of a seller who sells commodities, the authentication of the seller is performed via phone authentication at the time at which the seller subscribed as a member, and phone authentication for contact information is performed at the time of registering each commodity to be sold. At this time, when the time at which phone authentication is performed is within a month, and when the contact number registered in the seller's member subscription or the contact number registered for each commodity to be sold has never been used for illegal transactions, a separate mark (e.g. unique thinkCALL mark of thinkAT Co., Ltd) may be displayed. Here, the mark to be displayed may be set such that the mark is displayed differently depending on the levels of phone authentication.

For example, when the level of phone authentication is low, the mark may be displayed in gray color, when the level of phone authentication is middle, a normal mark may be displayed, and when the level of phone authentication is excellent, the mark may be displayed together with an animation effect or the like.

FIG. 12 illustrates the provision of a reliability service for a purchaser. When a purchaser subscribes as a member, he or she is authenticated using phone authentication, and when the purchaser purchases a commodity, phone authentication for a registered contact number is performed. At this time, when the time of phone authentication is within a month, the purchaser has a history of previously making a purchase decision using phone authentication, and the contact number registered in member subscription or the contact number for delivery has never been used for illegal transactions, a separate mark (e.g. unique thinkCALL mark of thinkAT Co., Ltd) may be displayed along with the level of reliability.

The method for displaying a mark is identical to that of FIG. 11, and thus a repeated description thereof will be omitted.

Meanwhile, the method for authenticating the user based on phone authentication according to the embodiment of the present invention may be implemented in the form of program instructions that are executable via various means for electronically processing information, and may be stored in a storage medium. The storage medium may include program instructions, data files, and data structures solely or in combination.

The program instructions recorded on the storage medium may have been specially designed and configured for the present invention, or may be known to or available to those who have ordinary knowledge in the field of computer software. Examples of the computer-readable storage medium include all types of hardware devices specially configured to store and execute program instructions, for example, magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Further the above-described medium may be a transmission medium, such as light, a metal line or a waveguide, which includes carrier waves for transmitting signals required to designate program instructions, data structures, etc. Examples of the program instructions include machine language code, such as code created by a compiler, and high-level language code executable by a device for electronically processing information using an interpreter or the like, for example, a computer.

The hardware devices may be configured to operate as one or more software modules in order to perform the operation of the present invention, and vice versa.

The present invention provides the user authentication method and system based on phone approval, so that the reliability of an actual user may be checked by performing authentication based on a call to a registered terminal so as to use a specific service.

Further, the present invention is advantageous in that it may perform authentication using a separate terminal via communication between a server for providing service and a server for performing phone authentication without causing a terminal that requested the service to perform authentication, thus making it impossible to perform forgery or falsification.

Furthermore, the present invention is advantageous in that it requests a user to enter approval or rejection for the user's transaction request via one-way authentication, and processes the transaction based on the entered result, thus strengthening an identification function and a non-repudiation function.

Furthermore, the present invention is advantageous in that it is capable of preventing abnormal transactions in advance and allows the system to automatically notify a user of the occurrence of a symptom such as suspected hacking, or allows the user to perceive the symptom and immediately make a report, thus preventing the occurrence of accidents related to security.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for authenticating a user and providing reliability, the method authenticating the user in response to a service request of a first terminal, comprising:
receiving, by a service provision server, a service provision request from the first terminal;
determining, by the service provision server, whether a type of service requested to be provided to the first terminal is a service requiring verification of reliability of the user, and transmitting, by the service provision server, a phone authentication request for the user, which includes the service type and authentication terminal information about a previously registered second terminal, to a phone authentication server if it is determined that the requested service is the service requiring verification of reliability;
sending, by the phone authentication server, an authentication information request guidance message including the service type to the previously registered second terminal, acquiring authentication information, performing authentication of the user, and transmitting a result of authentication to the service provision server;
when the result of authentication indicates success of authentication or confirmation of approval, providing, by the service provision server, the requested service to the first terminal; and
cumulatively storing, by the service provision server, the result of authentication, and statistically processing the stored authentication result, thus generating a reliability level.

2. The method of claim 1, wherein the type of service requiring verification of reliability is at least one of a member subscription request, a login request, an information change request, a content upload and download request, an information posting request, an adult information access request, and an electronic commerce request.

3. The method of claim 2, wherein each of the first terminal and the second terminal includes a plurality of terminals.

4. The method of claim 3, wherein:
when the type of service is electronic commerce, any one of the plurality of first terminals is a seller terminal and another one thereof is a purchaser terminal, and
when any one of the plurality of second terminals is a seller authentication terminal, and another one thereof is a purchaser authentication terminal.

5. The method of claim 4, further comprising:
when the type of service is electronic commerce, extracting, by the service provision server, commodities, delivery of which has been completed and which are waiting for a purchase decision to be made, from commodities purchased by the purchaser;
transmitting, by the service provision server, a purchase decision authentication request to the phone authentication server, wherein the purchase decision authentication request includes purchase information and recipient contact information registered when delivery of the extracted commodities, waiting for a purchase decision to be made, is requested;
transmitting, by the phone authentication server, a purchase decision confirmation request including the purchase information to a terminal of a recipient using the recipient contact information, acquiring purchase decision response information, and transmitting the purchase decision response information to the service provision server; and
updating, by the service provision server, a purchase confirmation state using the purchase decision response information.

6. The method of claim 5, wherein the purchase decision response information is acquired via Dual Tone Multi-Frequency (DTMF).

7. The method of claim 1, further comprising:
when checking of reliability of the user of the first terminal is requested by an additional terminal, providing, by the service provision server, the reliability level so that the reliability level is displayed on the additional terminal.

8. A system for authenticating a user and providing reliability, comprising:
a service provision server for receiving a service provision request from the first terminal, determining whether a type of service requested to be provided to the first terminal is a service requiring verification of reliability of the user, transmitting a phone authentication request for the user, which includes the service type and authentication terminal information about a previously registered second terminal, to a phone authentication server if it is determined that the requested service is the service requiring verification of reliability, receiving a result of authentication from the phone authentication server, and providing the service requested to be provided to the first terminal if the result of authentication indicates success of authentication or confirmation of approval; and
the phone authentication server for receiving the phone authentication request from the service provision server, sending an authentication information request guidance message including the service type to the previously registered second terminal, acquiring authentication information, performing authentication of the user, and then transmitting a result of user authentication to the service provision server,
wherein the service provision server cumulatively stores the result of authentication, and statistically processes the stored authentication result, thus generating a reliability level.

9. The system of claim 8, wherein the type of service requiring verification of reliability is at least one of a member subscription request, a login request, an information change request, a content upload and download request, an information posting request, an adult information access request, and an electronic commerce request.

10. The system of claim 9, wherein:
when the type of service is electronic commerce, the service provision server extracts commodities, delivery of which has been completed and which are waiting for a purchase decision to be made, from commodities purchased by the purchaser, and transmits a purchase decision authentication request to the phone authentication server, wherein the purchase decision authentication request includes purchase information and recipient contact information registered when delivery of the extracted commodities, waiting for a purchase decision to be made, is requested,
the phone authentication server transmits a purchase decision confirmation request including the purchase information to a terminal of a recipient using the recipient contact information, acquires purchase decision response information, and transmits the purchase decision response information to the service provision server, and
the service provision server updates a purchase confirmation state using the purchase decision response information.

11. The system of claim 10, wherein the purchase decision response information is acquired via Dual Tone Multi-Frequency (DTMF).

12. The system of claim 8, wherein the service provision server is configured to, when checking of reliability of the user of the first terminal is requested by an additional terminal, provide the reliability level so that the reliability level is displayed on the additional terminal.
